(19) United States
(12) Patent Application Publication
(10) Pub. No.: US 2012/0084227 A1
(43) Pub. Date: Apr. 5, 2012

(54) System and Method for Mapping and Compliance Monitoring of Banks

(76) Inventors: Avi Jorisch, (US); Jeffrey Chapman, (US); Brian Kolo, (US); Shon Myatt, (US); Ahmed I. Qureshi, (US)

(21) Appl. No.: 13/111,792

(22) Filed: May 19, 2011

Related U.S. Application Data
(60) Provisional application No. 61/389,990, filed on Oct. 5, 2010.

(51) Int. Cl. G06Q 40/00; G06F 17/30

(52) U.S. Cl. 705/347; 707/790; 707/E17.045

(57) ABSTRACT

A system and method for creating and maintaining a correspondent banking relationship mapping including current illicit designations. The system enables identification of a bank's correspondent relationships and the relationships of their correspondents. Through the system and method users can identify which banks have illicit relationships prior to engaging with banks or can be notified if the status of any banks which they have an existing relationships changes because a correspondent bank has entered into a correspondent relationship with an illicit banking entity.

This application claims priority to U.S. application Ser. No. 61/389,990 filed Oct. 5, 2010, currently pending which is incorporated herein by reference in its entirety.

The book ‘Tainted Money’ by Avi Jorisch, published by Red Cell IG on Sep. 1, 2009 is hereby incorporated by reference in its entirety.

The book ‘Iran's Dirty Banking: How the Islamic Republic is Skirting International Financial Sanctions’, by Avi Jorisch, May 20, 2010, Red Cell Intelligence Group is hereby incorporated by reference in its entirety.

### FIELD OF THE INVENTION

The invention, in general, relates to a system and method for mapping and monitoring the banking relationships of banking entities and identifying and alerting users of the system when a bank has a relationship with an illicit banking entity.

### BACKGROUND OF THE INVENTION

When a bank does not have a branch in a foreign country, it often pays a local bank to supervise its financial affairs in that foreign country and essentially act as its agent. The correspondent bank is then empowered to provide credit, deposit, collection, clearing, and payment services to customers in the main bank's name. This relationship allows a bank to conduct business in a given country without needing a physical presence in that country. Correspondent banks also provide access to foreign currencies and local markets.

However, banking institutions have increasing regulations, laws, and market pressure to avoid any business relationships with illicit banking entities. As an example, the 2010 Comprehensive Iran Sanctions, Accountability, and Divestment Act (CISADA) force U.S. banks to have an obligation to know not only who their customer is, but who their customer's customer is (correspondent's correspondent). Further, US Banks may be required to certify to the US government that they and their correspondent banking relationships have no direct or indirect business ties to designated banks or illicit entities, as defined by the U.S. government. In order to meet this demand, banking entities must know who their partners are conducting business with to determine if the banking partner has any illicit banking relationships or relationships with illicit banks.

Therefore, there is need for a system and method for mapping and monitoring the banking relationships of banking entities. Still further, there is a need for a system and method for identifying when a bank has a relationship with an illicit banking entity and for alerting users of any illicit banking relationships.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The present invention provides a system which allows banking institutions to know and see which banks they are doing correspondent business with or which banks they have a first level relationship with either providing or receiving. A second object of the present invention is to provide a system which allows banking institutions to see which banks their correspondent banks are doing business with or which banks they have a second or higher level relationship as a result of their partner's business relationships. The present invention provides this system by mapping every bank around the world, listing each bank's correspondent relationships, and then creating a relationship algorithm which maps banks to one another.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 provides a system diagram of the present invention.

FIG. 2 provides a flow diagram of the data build and mapping steps.

Particular embodiments of the present invention will now be described in greater detail with reference to the figures.

### PREFERRED EMBODIMENTS

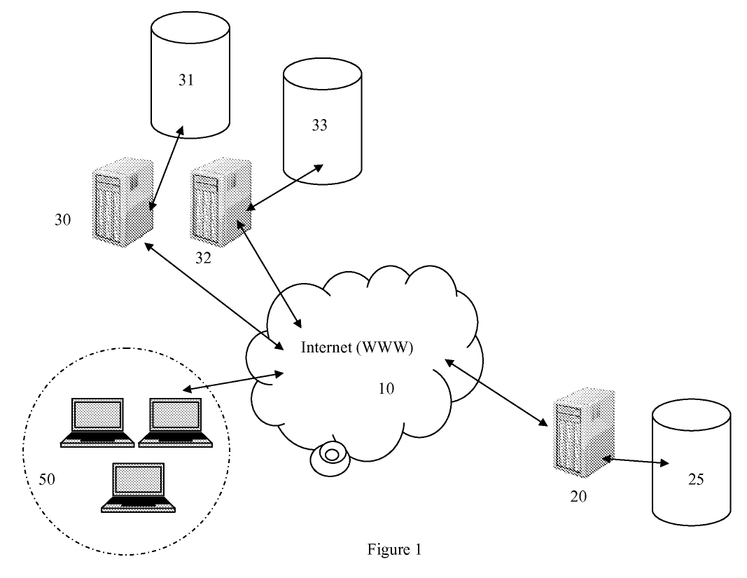

FIG. 1 illustrates a system diagram of the present invention and provides various computers, servers, and databases. Specifically the system provides one or more servers 20 which contain one or more applications to run a website, process data, and other applications for the system. The servers 20 are connected to one or more databases 25 which store user or customer information, banking institution information, correspondent banking relationship information, illicit banking entity information and other relevant banking and banking transactional information.

The website is accessible via the internet or World Wide Web 10 by users through their computers 50 or other electronic communications device. In one embodiment, the system provides various features and components including the ability for users to obtain reports, set up alerts, and research correspondent banking entities.

The system of the present invention also connects to various data sources through one or more servers 30 which are connected to one or more databases 31. By way of example, the server 20 includes an application to automatically retrieve updated Banking Data Source data on a daily or periodic basis by requesting and/or retrieving data from one or more Banking Data servers 30. The banking data servers 30 would retrieve the data from one or more databases 31 and such data would be transmitted to the system server 20 for processing. Such data would primarily consist of available banking data sources (BDS) which might include relationships between financial institutions (including account data), Society for Worldwide Interbank Financial Telecommunication (SWIFT) data, Bank Identification Codes (BICs), bank account numbers, bank beneficial ownership information, companies owned by the financial institution, the location(s) and jurisdiction(s) of operation, credit ratings, ownership type, name of regulator, and type of financial services provided to customers. Such sources might include Dun and Bradstreet reports, TransUnion, Equifax, Experian, and other applicable banking and credit data.

In addition, to the various available banking data sources, the system might also connect with banks directly or partners with additional or supplemental data or which provide ancillary services. By way of example, an application on server 20 can automatically retrieve updated data on a daily or periodic basis by requesting and/or retrieving data from one or more banks or partners through their one or more servers 32. The bank or partner servers 32 would retrieve the data from one or more databases 33 and such data would be transmitted to the system server 20 for processing. Such data sources might include, but are not limited to, government reporting agencies which report or identify illicit banking entities, information from banks directly including information on their correspondent banks, partners who offer correspondent oversight and foreign banking administrative services, data on banking executives which might help identify relationships between executives and illicit entities and those relationships as they move within the banking industry.

Various other servers, computers, databases, and access points could be added to the basic network structure displayed in FIG. 1 and would still be part of the scope of the system of the present invention.

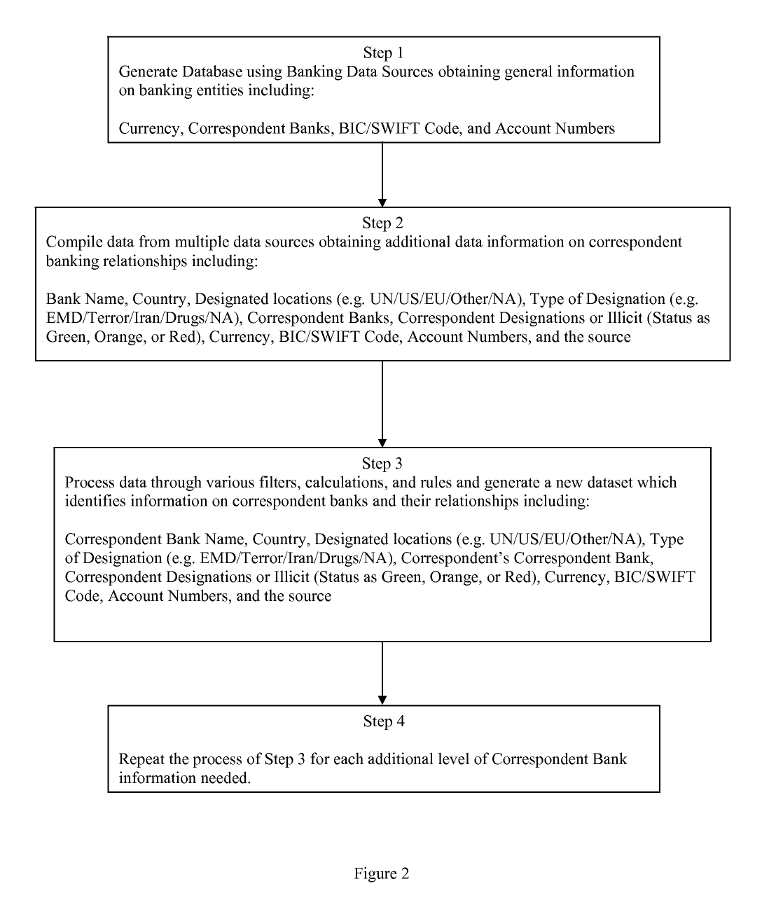

The database build and correspondent mapping process of the present invention will now be described in conjunction with FIG. 2. In Step 1 the system accesses Banking Data Sources (BDS). Although banks do not normally disclose their financial accounts to the public, there are a number of banking data sources that provide this type of information to subscribers for a fee. The system is able to access and use these data sources to map out a comprehensive list of correspondent relationships between financial institutions (including account data), Society for Worldwide Interbank Financial Telecommunication (SWIFT) data, Bank Identification Codes (BICs), and account numbers. Currently available BDS' only provide a list of who a bank receives correspondent services from, but not who it provides correspondent services to. In addition, currently available BDS' do not have the ability to analyze who a correspondent bank's correspondents are.

As seen in Step 2 on FIG. 2, the present invention utilizes various methods and applications to compile and extract the correspondent bank information on each financial institution around the world from the BDS information. The information is then used to populate a correspondent banking database with the following fields: (1) bank name; (2) country (in which the bank is located); (3) designated bank (e.g. UN/US/EU/Other/NA); (4) Type of Designation (e.g. EMD/Terror/Iran/Drugs/NA); (5) Correspondent Banks which are providing correspondent services; (6) correspondent designated (yes/no with Alert status as Green, orange, or Red); (6) currencies provided (USD, EUR, CHF, JPY, etc); (7) BIC/Swift Code of the financial institution; (8) account number; and (9) the source (BDS, Financial Institution, Other).

As seen in Step 3 of FIG. 2, the compiled data is then processed through various filters, algorithms, and rules to provide a Correspondent focused database and system. Current BDS' only list who a bank receives correspondent banking services from, but does not list who a bank provides correspondent services to. The system of the present invention identifies correspondent entities a bank provides services to and correspondent bank entities a bank receives services from. With the banking information for every financial institution in the world, the system maps out both forwards and backwards all the appropriate banking relationships. Additionally, the system is able to utilize information from individual financial institutions to verify correspondent and BDS information. The direct banking data will either corroborate existing information or provide additional data or questions for inclusion or further research.

Additionally, in Step 3, the banking data information is updated to reflect whether a certain banking entity is illicit. Governments around the world have identified a number of illicit banks. The system of present invention will obtain these identified illicit banks and flag these banks within the databases of the system. Further, the system will monitor various data sources and websites that include but are not limited to the following: 1) Treasury Department's Office of Foreign Assets Control (OFAC); 2) Treasury Department's Office of Financial Crimes Enforcement Network (FinCEN); 3) State Department's Office of International Narcotics and Law Enforcement Affairs; 4) European Union's Council; 5) Financial Action Task Force; 6) Egmont Group; 7) Wolfsberg Group; and 8) United Nations. Illicit or designated banks will be highlighted in the database. The identification of illicit banks is then updated within the database of the present invention. In addition, as Part of Step 3 a status marker can also be applied to the correspondent banks as will be described in more detail below.

Additionally, as seen in Step 4, the processing of data through the various filters, algorithms, and rules can be repeated to determine additional levels of correspondent banking relationships. Thus, the system can be used to generate correspondent banking relationships and potential illicit activity to the 1^{st}, 2^{nd}, 3^{rd}, 4^{th}, and 5^{th} level (and beyond, if desired) by repeating the Step 3 process using the list of correspondent banks from the previous level. Thus banks and financial institutions and utilize the system to identify appropriate banking relationships and monitor existing relationships.

As previously mentions, the system can also apply status markers to certain relationships. As the database is updated with the identifications of illicit banks, the relationships between financial institutions are mapped and the system can then appropriately identify the degree of risk to which financial institutions are exposed. In an exemplary embodiment the system will assign status markers to each financial institution according to the following: (1) a Green Flag may be used to identify banks which are not associated with any illicit banks, nor are any of its correspondent bank's correspondents; (2) an Orange Flag may denotes banks that are associated with a country or jurisdiction that is suspected of money laundering, or other illicit activities. (3) a Red Flag may be used to identify that a bank that has a direct correspondent relationship with a designated illicit entity. (4) a half red flag may be given if one of a bank's correspondents' has a direct relationship with a designated illicit entity. When an illicit bank is determined the user/customer will receive a synopsis of the illicit bank.

The system of the present invention can be used to provide a snapshot in time which will provide clients with a dossier of whom their correspondent banks are and who their correspondent's correspondents are along with appropriate status markers and synopsis of any illicit banks in the snapshot. This will provide banks with a degree of confidence that neither they, nor anyone they are doing business with is providing correspondent services to illicit banks.

The system of the present invention can be used to provide ongoing monitoring and alerts to ensure that when correspondent relationships change, the bank level of risk has not changed. Correspondent banking relationships change on a fairly regular basis and banks will want to know immediately if anyone in their orbit is involved with illicit entities. In addition, government and international organizations around the world update their lists of illicit entities on a fairly regular basis. The system of the present invention will provide an up to date database which will reflect this and send alerts to inform users when such an event has occurred and if it affects them in any way. Such alerts might be via email, text messages, RSS, or similar alert function.

The system of the present invention will also be able to extract and present country banking reports, partial country banking reports, currency reports, and designation-type reports to its users.

Country banking reports: There are instances when it is beneficial to know where the banks of an entire country are either giving or receiving correspondent banking services. Examples might include State-Sponsors of Terror, tax havens, and countries that are known to facilitate money laundering activities. As a result of the methodology above, the system will able to provide this information by filtering based on country.

Partial country banking reports: There are instances when it is beneficial to know where more than one bank is either giving or receiving correspondent banking services. Examples might include all the U.S. designated Iranian banks. As a result of the methodology above, the system will able to provide this information by filtering based on designated banks.

Currency Report: There are instances when it is beneficial to know which currencies are offered by and to individual or a number of banks. As a result of the methodology above, the system will able to provide this information by filtering based on individual currencies.

Designation-Type report: There are instances when it is beneficial to know what banks have been designated. As a result of the methodology above, the system will able to provide this information by filtering based on designation type.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

Bank Rating System

When examining CISADA, a numeric value may be computed for a bank based on the number of illicit banks that are connected at each degree of separation. When a US bank is within two degrees of separation to an illicit bank, CISADA violations may be indicated.

In this example, a list of illicit banks is identified. For a given initial bank (not an illicit bank), the degree of separation between the initial bank and each illicit bank is computed. If there are illicit banks as a separation of one degree, the initial bank is given a score of 9. If the minimum separation degree between the initial bank and any illicit bank is 2, the initial bank is given a score of 7. If the minimum separation degree between the initial bank and any illicit bank is 3, the initial bank is given a score of 4. If the minimum separation degree is between the initial bank and any illicit bank is 4 or greater, the initial bank is given a score of 4.

This score may be modified based on the number of banks at a given degree. For example, if the minimum degree of separation between the initial bank and any illicit bank is 2, but there are three illicit banks with this separation, the score for the initial bank may be modified from the preliminary score of 7. For example, we may add 0.5 points for each bank at this separation degree in excess of one. Thus, in this example, the final sore for the initial bank may be 8.

Furthermore, the score may depend on banks that are not on the list of illicit banks. Other banks may be identified and their separation degree may be incorporated into the score. For example, a list of banks from rough states may be compiled, and the degree of separation between the initial bank and these rough banks computed. A score may be assigned using a similar method as described above. This score may then be multiplied by a factor and the result added to the above score.

In the above embodiments, the rating score for a bank may be provided to a consumer. The consumer may be the general public, and the score may be simply published on a website, newspaper, magazine, or other publishing method targeted toward general public distribution. Alternatively, the consumer may be a bank wherein the consumer is interested in knowing the rating of the bank. Moreover, the consumer may be a bank interested in knowing the rating for another bank.

In another embodiment, the score computed from the above is mapped to a grade A, B, C, D, or F with lower scores (preferred) mapping to A, and higher scores (not preferred) mapping to F, and scores in between mapping to B, C, or D. Here, banks are given a score of A through F with A best and F worst.

In another embodiment, the A-F score from above is combined with a second score. The second score may be based on factors related to: banks undergoing criminal or civil investigations for money laundering and/or terrorism finance, banks recently fined for engaging in money laundering or terrorism finance-related activities, or banks fined for risk related behavior under a country or international law. Here, the score for a bank may be modified if the bank has any of these factors. Alternatively, the score for a bank may be modified if the bank has correspondent accounts (nostro or vostro accounts) with banks that have these factors. In this case the score for a bank may be based in part on potential CISADA violations.

Alternatively, the score for a bank may be modified if the bank has been issues CISADA violations from the US Treasury. In this case the score for a bank may be based in part on CISADA sanctions issued by the US Treasury.

Moreover, a bank rating may be the direct product of two bank ratings where a first bank rating is computed without examining CISADA violations, and where a second rating is computed exclusively with respect to CISADA violations. Thus, a bank may be rated as AC where the first letter ‘A’ represents the first rating without CISADA violations and the second letter ‘C’ represents the bank rating using only CISADA issues. This rating method has the benefit of separating the traditional bank rating methods from the CISADA compliance rating methods.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A system of determining correspondent relationships between banks comprising:
a. one or more Banking Data Sources;
b. a means for extracting correspondent bank information from the Banking Data Sources;
c. a correspondent banking database wherein the correspondent banking database is populated from the correspondent bank information;
d. a means for processing the correspondent banking database to produce a correspondent focused database;
e. a means to verify correspondent information;
f. a means to compute the minimum degree of separation between two banks in the Bank Data Sources;
g. and where the minimum degree of separation is at least two degrees.

2. The system of claim 1 where the correspondent banking database comprises the fields of
a. Bank Name;
b. Country Location corresponding to the Bank Name;
c. Bank Designation;
d. Type of Designation;
e. Correspondent Banks which are providing correspondent services;
f. Correspondent Designated;
g. Currencies provided;
h. BIC and/or Swift Code of the financial institution;
i. Account Number;
j. Source

3. The system of claim 2 where the correspondent focused database contains nostro relationships.

4. The system of claim 2 where the correspondent focused database contains vostro relationships.

5. A method of rating banks comprising:
a. Identifying a list of illicit banks;
b. Identifying a list of banks to rate;
c. Identifying a Banking Data Source;
d. Computing the minimum degree of separation between each bank to rate and each bank on the list of illicit banks;
e. Computing a score for each bank on the list of banks to rate wherein the score is based in part on the minimum degree of separation between the bank and the list of illicit banks;
f. and providing the score for at least one of bank on the list to banks to rate to a consumer.

6. The method of claim 5 where the Banking Data Source contains a nostro relationship.

7. The method of claim 5 where the Bank-Linking Rating Source contains a vostro group.

8. The method of claim 5 further comprising a bank rating system that does not contain CISADA violations as part of the computation of a bank rating.
